(19) United States
(12) Patent Application Publication
(10) Pub. No.: US 2004/0237756 A1
(43) Pub. Date: Dec. 2, 2004

(54) Computer-aided music education

(76) Inventor: Angus G. Forbes, Brooklyn, NY (US)

Correspondence Address: Angus G. Forbes, 64-04 Utopia Parkway, Fresh Meadows, NY, 11365, US

(21) Appl. No.: 10/445,663

(22) Filed: May 28, 2003

(51) Int. Cl. G09B 15/02

(52) U.S. Cl. 84/477 R

(57) ABSTRACT

A set of methods and computer-aided music education system to accelerate conceptual comprehension in learning and technical proficiency in performing a musical piece or lesson. A musical piece is comprised of various interwoven musical concepts, which serve as the basis for identifying performance issues with particular musical concepts. Based on this identification, customized lessons are created that focus on the improvement of these specific musical concepts. Thus, through the iteration of the above process, a series of lessons is dynamically generated based specifically on the user's performance. This series constitutes a feedback loop that can be presented continuously, in real-time, or in discrete steps. An interactive three-dimensional visualization of the lessons helps the user to understand the relationship between the various musical concepts in the piece or lesson and to perform them on a musical instrument.

### REFERENCES CITED

### U.S. Patent Documents:

6,066,791 May 2000 Renard 84/477R

6,018,121 January 2000 Devecka 84/743

6,399,869 June 2002 Sagastegui 84/738

5,746,605 May 1998 Kennedy 434/307R

5,690,496 November 1997 Kennedy 434/307R

5,585,583 October 1993 Owen 84/470R

### FIELD OF THE INVENTION

This invention relates to computer-aided music education. More particularly, this invention defines a set of interrelated methods to accelerate the learning of conceptual and technical aspects of a musical instrument.

### BACKGROUND OF THE INVENTION

Currently, computer-aided music education systems suffer from a number of general problems that hinders their explicit goal of facilitating rapid improvement of musical competencies.

First, an excess of ambiguity in modeling both the conceptual and technical aspects of music prevents easy assimilation of those aspects. This includes a music notation that is incapable of representing subtleties of realistic performance, as well as a general inability to sufficiently define and present musical concepts with an appropriate level of granularity. Most computer-education systems tend to represent music very rigidly, and none have the flexibility to describe complex interrelations of musical concepts. For example, one computer-aided music education system described in U.S. Pat. No. 5,746,605 features a method to present music at varying stages of complexity. This method has limited effectiveness because it does not provide a feedback loop that can identify particular weaknesses for specific users. Instead, it only cuts a musical piece into arbitrary levels of complexity, and does not create customized lesson material based on those identifications. Moreover, this method defines complexity solely in terms of rhythmic structure, and may fail to structure musical concepts in a manner more appropriate to a particular musical piece or lesson.

Second, because of the ambiguity and lack of granularity in modeling musical concepts, feedback given to a musician is not presented in a way that allows him or her to learn quickly. In general, computer music education systems are non-adaptable and do not provide custom feedback to a musician, based on an accurate analysis of a musician's performances. While many systems provide a rudimentary scoring of performance, none use this scoring to dynamically present new lessons, which is the way a teacher would respond to a student's performance. That is, by assigning new material based on the student's strengths and weaknesses in certain aspects of the performance. For instance, one computer-aided music education system, described in U.S. Pat. No. 5,585,583, claims that it can generate suggestions for minimizing differences between the output of a musical piece on a computer and a user's performance of it. In fact, because that invention has no recognition of music as a series of layered musical concepts, the feedback it describes is simply to allow a user to re-perform a musical piece, to watch a video of an expert performing the musical piece, and/or to decrease the tempo of the musical piece. That is, the feedback is generic and not adequately tailored to the student's performance of particular musical concepts within a musical piece or lesson.

Third, computer music education systems do not generally take advantage of the various and increasing multi-media capabilities of modern home computers to successfully present complex musical ideas to a musician. Most systems use one or more of the following methods: imitation of traditional music notation; incorporation of videos of human performance; and affixing lights to the instrument that flash to indicate when particular notes are to be played, or by having a graphical representation of an instrument become highlighted when particular notes are to be played. (e.g., U.S. Pat. Nos. 6,066,791, 6,018,121, 6,399,869, for a recent example of each of these, respectively; U.S. Pat. Nos. 5,690,496 and 5,585,583 for examples utilizing all three of the above methods). While any of these may be helpful, they are all more or less simple adaptations of traditional non-computer-aided methods.

In sum, there is a need for computer-aided methods that can model musical concepts and techniques intuitively and accurately; provide useful customized feedback based on a student's performance; and that more successfully takes advantage of the computer's ability to merge the aural and visual so as to present musical information in an adaptive and easily understandable manner.

The invention described herein presents interrelated methods that address all of the general problems above, which, when implemented together, define a system that accelerates technical understanding and deepens the comprehension of musical concepts.

### SUMMARY OF THE INVENTION

The current invention is a system of interlocking components, which provide methods to accelerate the learning of music. First, we provide methods for accurate conceptual and technical modeling. Second, we provide methods for instant customized and interactive feedback of a lesson performance. Third, we provide methods for the creation of customized lessons based on analyses of student performance. Fourth, we provide methods for the iterative process of creating customized lessons based on the analysis of a performance of a customized lesson, which is themselves analyzed. Fifth, we provide methods to present the above iterative process seamlessly, in real time. Sixth, we provide a method for presenting an intuitive analogous visualization of the auditory music lessons and for displaying feedback of the performance of those lessons.

The first group of methods provides for modeling music in such a way that it both accurately represents music technically and conceptually. Utilizing the flexibility of the MIDI (Musical Instrument Digital Interface) protocol, the invention provides an extended interface to manipulate musical concepts, such that a musical piece of any complexity can easily be created which accurately mimics a real musical performance, including subtleties of timing and volume. In this invention, we define a musical piece as a container of group of musical objects. A musical object (henceforth MO) is itself defined as a container of other MOs and/or music events (typically MIDI noteOn and other MIDI events). Thus a musical piece of any complexity can be composed via the grouping together of some number of MOs. Additionally, this invention provides methods to decompose music into smaller conceptual pieces. That is, a complex piece of music can be demarcated into sets of simpler and/or shorter concepts, based on musical ideas, such as themes, phrases, limbs, sticking, fingering, instruments, keys, volumes, timing, etc. A musical piece thus may recurse through various layers of musical meaning until it is “atomic”, or made up of only notes. This conceptualization allows for more accurate identification of a student's success or failure in the performance of a musical piece or lesson (both of which can be defined, fundamentally, as a MO that is not contained by any other MOs, or a top-level MO). Thus, the invention can, using methods described below, identify both the particular notes that the student misplayed, as well as make an educated guess as to what concepts the student has not yet mastered.

Based upon the above methods of accurate and recursive modeling, the invention can provide instant customized feedback. As a student performs a particular lesson, the invention scores each individual note based upon accuracy of timing and volume, and also scores each MO which contains that note (and simultaneously, each MO which scores that MO, etc). When the performance is complete, the computer then uses an algorithm to first determine what the weakest MO is, and then further to identify all related MOs (i.e., the MOs which contain the weakest MO, and/or the MOs which overlap the weakest MO). Furthermore, there is a method to create customized lessons based upon the identification of the weakest MO and related MOs. Depending on the MO, the invention may create a new lesson based on the identified MOs by doing one or more of the following: ignoring the weakest MOs; focusing on the weakest MOs; decreasing the tempo of the newly created lesson. Additionally, the invention provides methods for the identification of badly performed MOs and the creation of customized lessons based upon that identification to happen in real time. Thus, a single lesson can be made to automatically repeat, each time modulating so as to accelerate the learning of the precise parts of the music which are causing the student problems. If the student fails to perform a lesson successfully, a new customized lesson will seamlessly be appended to the current lesson with no noticeable discontinuity. If the student performs a lesson successfully, the prior lesson will seamlessly be appended to the current lesson. Once we are at the original lesson, and the student performs it successfully, then the real time lesson will end.

This invention is also directed to a method for visualizing music in three dimensions. The visualization has the following elements: accurate representation of timing and volume; movement of note representations along a three dimensional axis; visual notation of multiple conceptual markers; real-time representation of student's performance against music; mapping of instruments to channels analogous to actual instrument, key, or note positions; the use of different shapes, colors, or sizes for different phrases and/or concepts.

### BRIEF DESCRIPTION OF THE DRAWINGS

FIG. 1 is an illustration of an example depiction of a music object container.

FIG. 2 is a diagram illustrating the steps involved in a general method for demarcating a musical piece into music objects.

FIG. 3 is a diagram illustrating the identification of a set of weak music objects from a performance of a musical piece.

FIG. 4 is a diagram illustrating the creation of a customized music lesson based on the identification of a set of weak music objects.

FIG. 5 is a diagram illustrating the iterative process of continually creating new customized lessons based on the analysis of a performance of a preceding lesson.

FIG. 6. Is a diagram illustrating a method for presenting the method illustrated in FIG. 5 in real-time, in which the new custom lesson is created based on an analysis of a performance some number of repetitions of the original lesson.

FIG. 7. Is a diagram illustrating another method for presenting the method illustrated in FIG. 5 in real-time, in which the new custom lesson is created based on an analysis of only a portion of the original lesson.

FIG. 8. Is a diagram illustrating another method for presenting the method illustrated in FIG. 5 in real-time, in which two analysis engines are engaged concurrently, allowing for full analysis of all performance data.

FIG. 9. Is a diagram illustrating the transformation of music notation to a three-dimensional topological visualization for drumset.

FIG. 10. Is a diagram illustrating an example note mapped from music notation to a three-dimensional topological visualization described in FIG. 9.

FIG. 11. Is a diagram illustrating an example of a musical phrase mapped from music notation to a three-dimensional topological visualization in FIG. 9.

### DETAILED DESCRIPTION OF THE INVENTION

This invention makes use of the common MIDI (Musical Instrument Digital Interface) protocol to model music, taking advantage particularly of its ability to represent volume and timing to a high degree of accuracy.

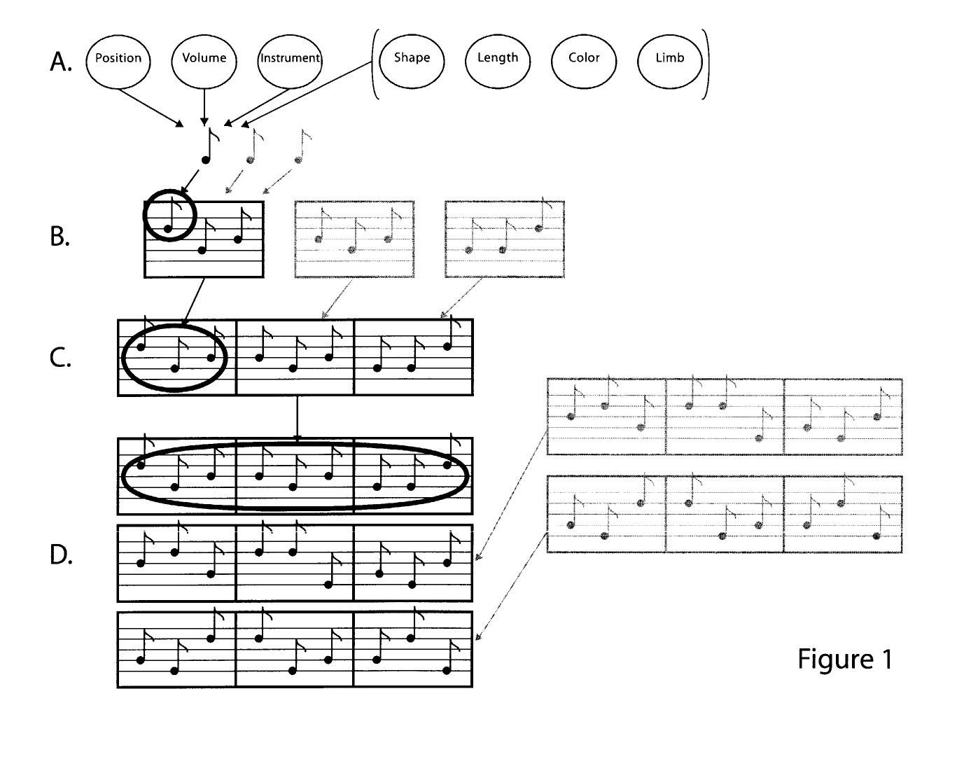

The invention defines music as structured layers of Music Objects. A Music Object (MO) is simply a collection of either MIDI noteon events, or other MOs, or both. By providing and abstraction of music as recursive levels of musical data, we provide a flexible way to represent various aspects of musicality in a multiplicity of ways. For example, a piece of music can be thought of as a single conceptual piece, which can be broken into large conceptual phrases, which are then further broken into smaller parts, and then can be split into individual voices, until we finally reach an atomic level of individual notes. Additionally, since any MO can be contained by one or more other MOs, we can represent ambiguous and complex relationships within a music piece. A single note, or group of notes, can thus belong to more than one MO at the same time. FIG. 1 describes an example of musical objects being composed into a single container, or musical piece.

The definition of a structure of a musical piece can be made by a human, either through composing a piece out of smaller musical pieces, or by using a tool to mark musical concepts from an existing piece. Many methods exist that allow a computer to automatically recognize patterns, and any of these can be used to detect layers of musical information, with varying degrees of success. Even a general method which arbitrarily breaks a musical piece into MOs is effective in most situations. A simple method is described below, geared toward the drumset. For purposes of this method, we define a split which separates limbs, instruments, keys, or volumes as a “horizontal” split, and a split which separates a MO into pieces based on timing information (i.e., before or after a particular time) as a “vertical” split.

a) Method to Split a Musical Piece into Layers of Music Objects.

1. Split a musical piece horizontally into different MO based on their limb.

2. For each separate limb MO, split each MO vertically into two separate pieces in the center of the piece.

3. For each separate MO created from step 2, split the MO horizontally into separate MOs based on the exact instrument.

4. For each separate MO created from step 3, split the MO vertically in half.

5. Repeat the vertical split in step 4 for each separate MO created from step 4 until a minimum time has been reached.

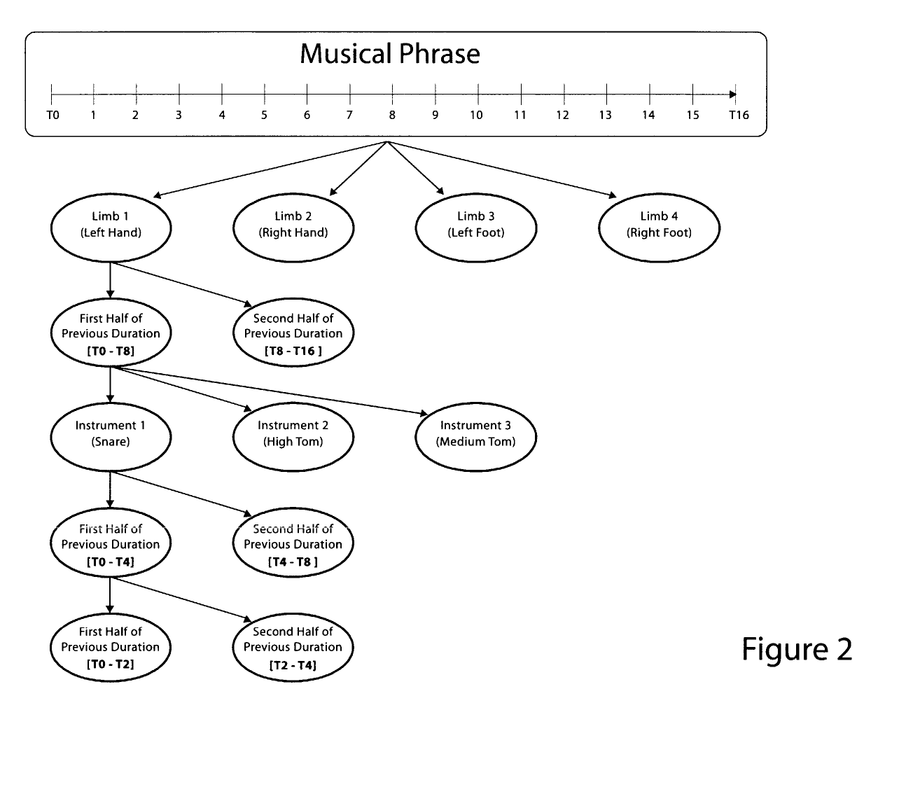

Two things should be pointed out here. First, that this method can be easily modified to other situations. For example, if the musical piece to be defined as layers of MOs is to be performed on a piano, we can replace the word “limb” in step 1 with “hand” or “octave”, and replace the word “instrument” in step 3 with the word “key”. Additionally, depending on the length of the piece, we may get a richer subset of MOs if we perform step 4 and 5 a number of times before performing step 3. Secondly, this general method fails to identify complexity and ambiguity in musical concepts, for instance, in an interesting piece where a particular note or phrase can be said to belong simultaneously to multiple MOs, and fails to distinguish between concepts that span more than one time segment, or more than one limb. Nevertheless, even an arbitrary division of a musical piece into layered MOs is sufficient to prepare for the following methods used to prescribe customized feedback to a user. FIG. 2 describes the steps involved in the automatic decomposition of a musical piece into MOs.

The next set of methods defined by this invention involve identifying weaknesses in a student's performance of a particular music piece in which layers of MOs have been defined. This invention requires input from a musical instrument. This input is either received as MIDI noteOn events, or is to be translated into MIDI events in real time. All standard electronic instruments support the MIDI protocol, and systems exist which can translate acoustic instruments to MIDI, with varying degrees of success.

We define a lesson as a particular musical piece which is itself a MO, containing one or more layers of MOs within it. In real time, as the student performs the lesson, the invention scores each note based on accuracy of timing and volume. Additionally, each note necessarily belongs to one or more MO, and we adjust the score of that MO which contains the note. Furthermore, each MO may be contained by one or more MOs, and we adjust the score of those MOs accordingly. At each point in time during the student's performance the invention gives instant feedback to the student on an individual note level, as well as at the various conceptual level defined by the MO structure. This feedback is displayed graphically (this will be described later) as well through updating various sets of metrics regarding the various musical aspects, including timing and volume information for each conceptual layer.

After the entire lesson is played, we analyze the student's performance by interpreting the scores of the MOs in a number of different ways. Depending on the lesson, we can utilize particular methods to assess the areas which the student had the most difficulty performing. A general method of analysis is illustrated in the following steps.

B) Method to Identify Areas of Weakness in a Student's Performance of a Lesson.

1. If no MOs have a low score, then the lesson was performed successfully.

2. Otherwise, find the MO with the lowest overall score and mark it as the weakest MO.

3. If the weakest MO is contained by another MO which is not the outermost MO (i.e., the lesson itself), check the score of that surrounding MO. If the surrounding MO's score is itself below a particular threshold, mark instead the surrounding MO as the weakest MO.

4. Otherwise, if other MOs (which do not contain the MO with the lowest overall score) overlap the MO with the lowest overall score (i.e., are to be performed at the same time), check the score of those MOs. If any of the overlapping MOs have a score below a particular threshold, mark all of those MOs as the weakest MOs.

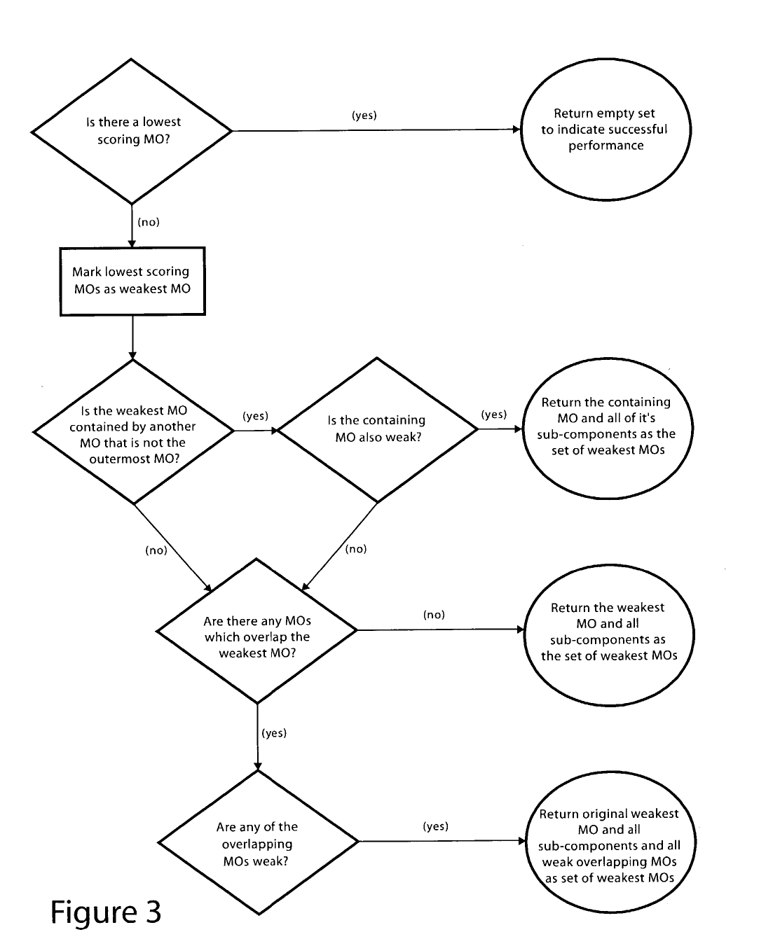

When these steps are completed, the invention will have made a reasonable guess as to the specific concept that the student is failing to perform (if any). The result of this method is similar to the result an expert human observer might notice when attempting to identify problems in a student's performance. It is important to note that the above steps are generalized, and that depending on the lesson performed the invention will also utilize steps to identify more than one weakest MO, or a step to recurse upward to further surrounding MOs, or a step to investigate the content of surrounding or overlapping MOs before counting them as part of the set of weakest MOs. Moreover, as explained before, we can assume that greater accuracy will be achieved if the MOs themselves were identified by a capable human, or by using a expert pattern recognition tool. FIG. 3 describes the steps involved in determining the set of weakest MOs.

Based on the above methods of identifying weak areas in a student's performance, and associating them to a set of one more weakest MOs, the invention is now able to utilize this information to create a new appropriate lesson to assist the student in improving his ability to perform these weak areas. The generalized method to create a new lesson is as follows:

C) Method to Create Customized Lesson Based on Identification of a Set of Weakest Mos.

1. Identify the pulse structure of original lesson.

2. Perform either of the following steps:

a) Mark the set of weakest MOs as to be used in new lesson construction.

b) Mark the set of weakest MOs as not to be used in new lesson construction.

3. If necessary, mark that there will be a decrease in tempo in the construction of a new lesson.

4. Create a new lesson out of MOs marked above at the tempo marked above based on the pulse structure identified in step 1.

Thus, the new lesson will have the following features: it will have a structural and temporal relationship to the original lesson, it will be simpler than the original lesson, it will either focus on the weakest areas of the student's performance or focus on strengthening the areas that were not considered weak, and it will either be the same tempo or slower.

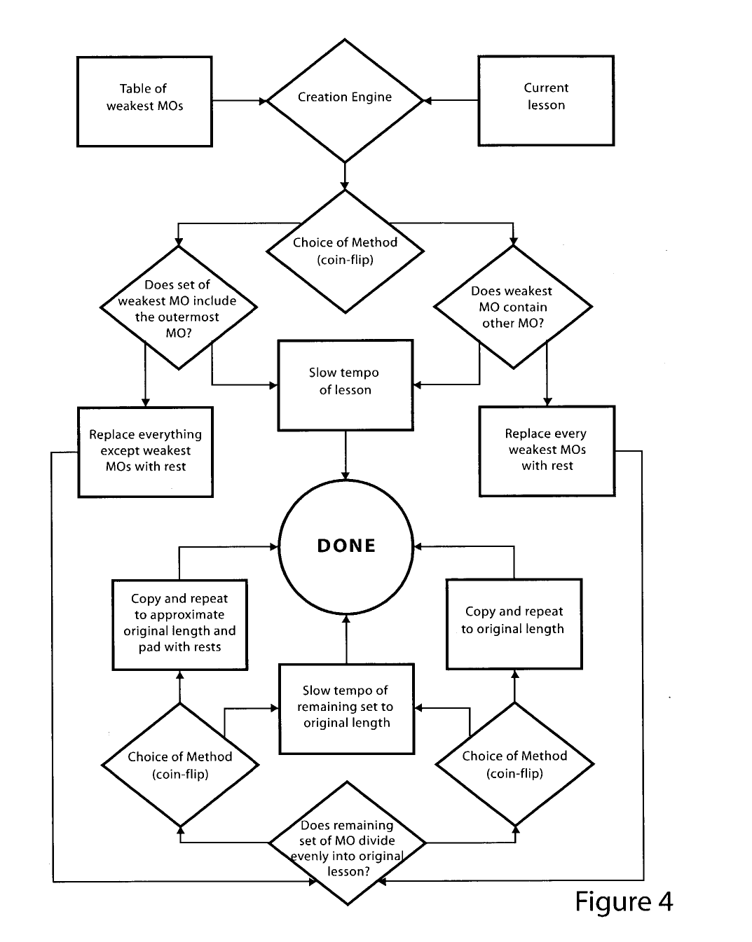

Some general points should be addressed. Step C1 can be accomplished in a number of different ways. Most simply, it will assume that the original lesson was evenly divided by a number of MOs according to method A above, and create a new lesson according to step C4 that is the same length as the original lesson. In more complex situations, this will be less effective, and a more robust pattern recognition system can insure that the new lesson adheres to both the overall length of the original lesson (or a reasonable partial of it) and its structure. One method to insure continuity between the original and custom lesson is to simply place the MOs that are to be used in the same relative position that they were in the original lesson; each MO that isn't used can be replaced by a rest of the same length as that MO. In certain cases, methods to manipulate the length of particular MOs can be employed to chop out parts of a MO, or to pad it with notes or rests. Step C2, which chooses either to focus on the set of weakest MOs or to ignore it, can be defined programmatically, or left up to chance. In practice situations, both methods are alternatively employed to learn a particular musical concept that exists within other musical ideas. Seeing the lesson from both sides, as it were, allows a student to perceive more clearly the context in which his difficulties originate. Step C3, dealing with a decrease in tempo, can be implemented in cases where it is impossible to reduce a lesson to sub-MOs, or in cases where everything or nearly everything can be considered part of the weakest MO set. FIG. 4 describes the steps involved in creating a new customized lesson based on the identification of the set of weakest MOs within a performed lesson.

Although many methods can be utilized to refine the system of identifying a set of weakest MOs from a particular performance of a lesson, as well as to refine the system of creating customized lessons based on this identification, even generalized implementations will be highly effective. Using steps B and C iteratively creates a feedback loop that provides both instant-detailed information about a performance issue and a means to improve it. Thus a general method defining accelerrated learning can be described thus:

D) Method to Accelerate Learning and Performance of Various Musical Concepts in a Musical Lesson.

1. Use method A to define a lesson with layers of musical concepts.

2. Use method B to identify problems in performing a lesson.

3. Use method C to create a customized lesson that focuses on improving the problems identified in step 2. 4. Repeat step 2 and 3 until there are no problems.

More specifically, we can imagine a list of lessons which grows as a student fails to perform a lesson. If the student successfully performs a lesson, then that lesson is removed from the list, and the student returns to the previous lesson. Once he has worked through all his problems, he will have returned to the original lesson and performed it successfully, at which time the iterative loop ends.

In the event that there are multiple weak areas, overlapping or not, the effect of this system is that it chooses one of them, simplifying the lesson as it isolates a problem until the student is able to play it. Once he has mastered a customized lesson, the system returns to the previous lesson, which is by definition of a higher complexity. If the student still has weaknesses in this lesson, yet another new customized lesson is created to work on those issues. Thus the system iteratively bounces between simpler and more difficult lessons as needed until the student has eventually mastered all aspects of the lesson.

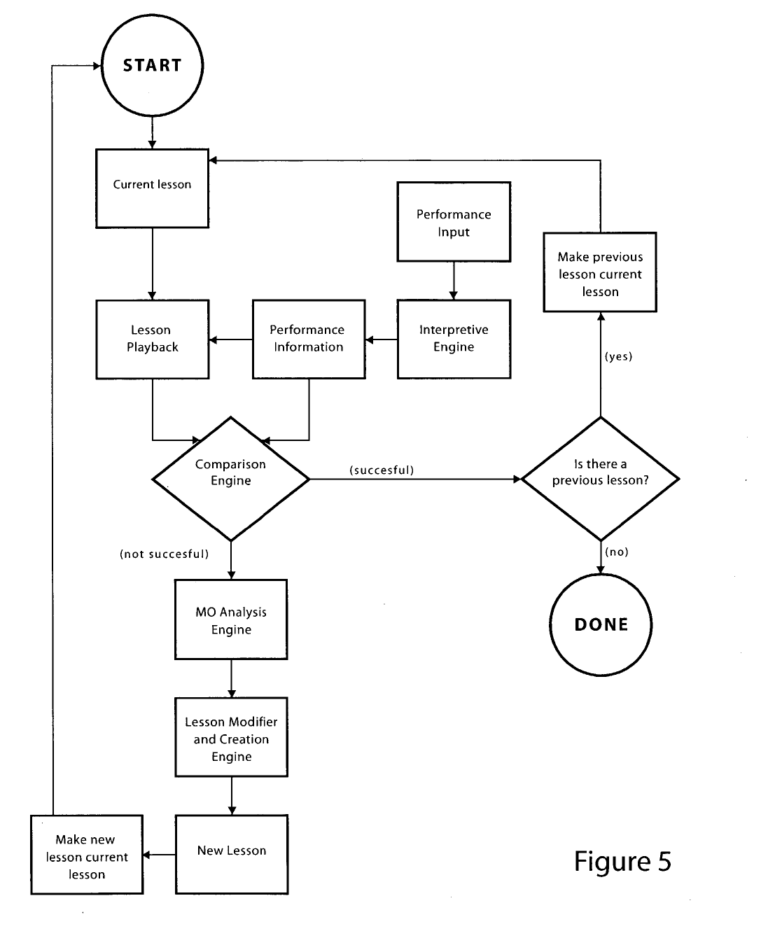

Of course, if the lesson is highly focused on a single musical concept, then the breadth and depth of the customization, and the number of iterations, will be less, and the lesson will be learned more quickly. However, this invention also allows there to be no granularity in lesson definition. For example, a lesson can be defined as an entire piece of music with a large number of musical concepts intertwined. As long as some version of method A exists, them the student's weaknesses in performing the piece will itself direct the lesson plan. FIG. 5 describes the steps involved in iteratively processing of methods B and C.

Additionally, this invention contains methods to facilitate the iterative process of method D by using a system whereby the iterations of steps D2-D4 occur continuously in real time, which no break between the original lesson and a newly created lesson, or between two customized lessons.

Because the process of analyzing the performance of a lesson takes some time (although this is minimal on fast computers) and because the visualization component (described below) requires a few seconds so that the user can see the notes as he prepares to play them, we describe some methods for presenting effective methods to present an iterative flow of lessons in real time.

E) Methods for the Construction of Continuous Customized Lessons.

1. One version of Method E is as follows. Repeat some lesson X some number of times. While the student is performing the last repetition of lesson X, use method B to identify the weakest areas in each performance of each previous performance of lesson X. Determine if there is one set of weakest MOs which is found in the analysis of more than one performance. If so, use that as the set of weakest MOs when applying Method C to construct a new lesson. Otherwise, choose a set of weakest MOs from one of the performances based on some criteria, such as: the set containing the most weakest MOs, or the set containing MOs which span the greatest length of time. Use Method C to create a new customized lesson Y which is appended to the final lesson X which is currently being performed. Repeat this method, using lesson Y. One flaw in this method is that the final performance of a particular lesson will never be analyzed. However, in most situations this will not matter, and we can increase the number of repetitions so that we have sufficient data to work with despite the absence of incorporating the final repetition.

2. Another version of Method E is as follows: present some lesson X a single time. At a time during the performance some moments before the end of the lesson, analyze (Method B) what has so far been performed and create (Method C) a new lesson Y based on this analysis. Repeat this method-using lesson Y. Similar to E1, we will not analyze a small portion of each lesson.

3. Yet another version of Method E is as follows: present some lesson X some number of times. After the first repetition of lesson X has been performed (and during the performance of the second repetition), analyze the performance of the first repetition and create a customized lesson M which is appended to the final repetition of lesson X. For each subsequent lesson X, similarly create a customized lesson N, 0, P, etc, utilizing methods B and C. Continue this process of analyzing the previous lesson and placing the created lesson after the final lesson. In this method, all notes will be analyzed, but there may be a confusing divergence of customized lessons if the student has multiple weak areas when performing a particular lesson.

Any of the above general methods, as well as others based on similar principles, will effectively engage the student while he seamlessly responds to the lessons. The benefit of these methods of feedback is that the user can remain unaware that he or she is receiving feedback, and is able to stay focused on performing the lessons without interruption. That is, the student is simply playing a continuous musical phrase that happens to decrease and increase in complexity, and meanwhile mastering all the various aspects necessary to successfully play the original musical piece or lesson material.

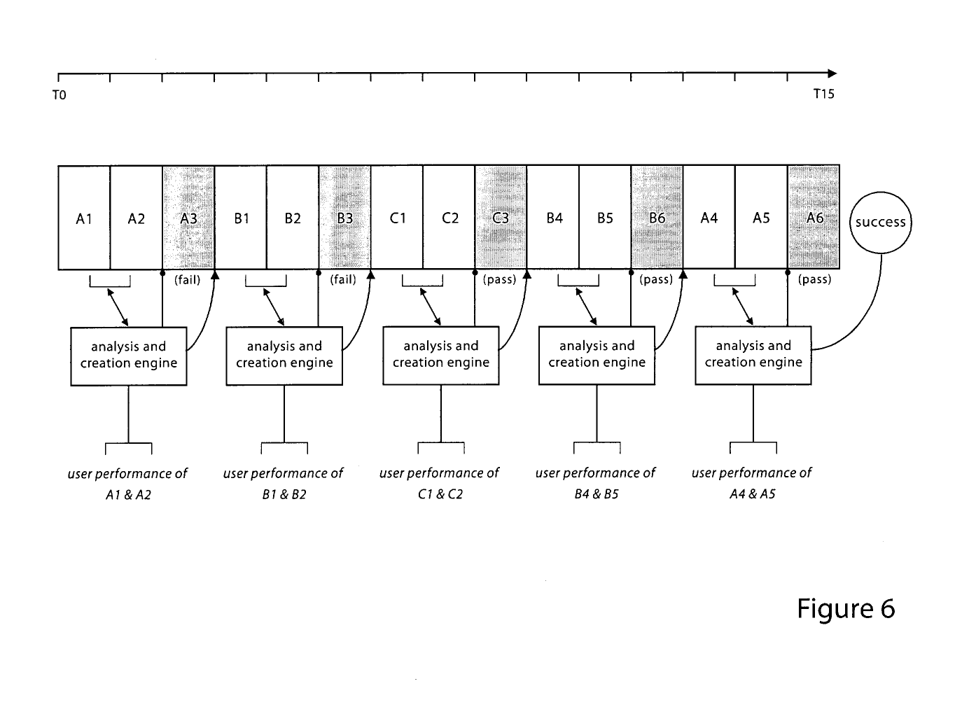

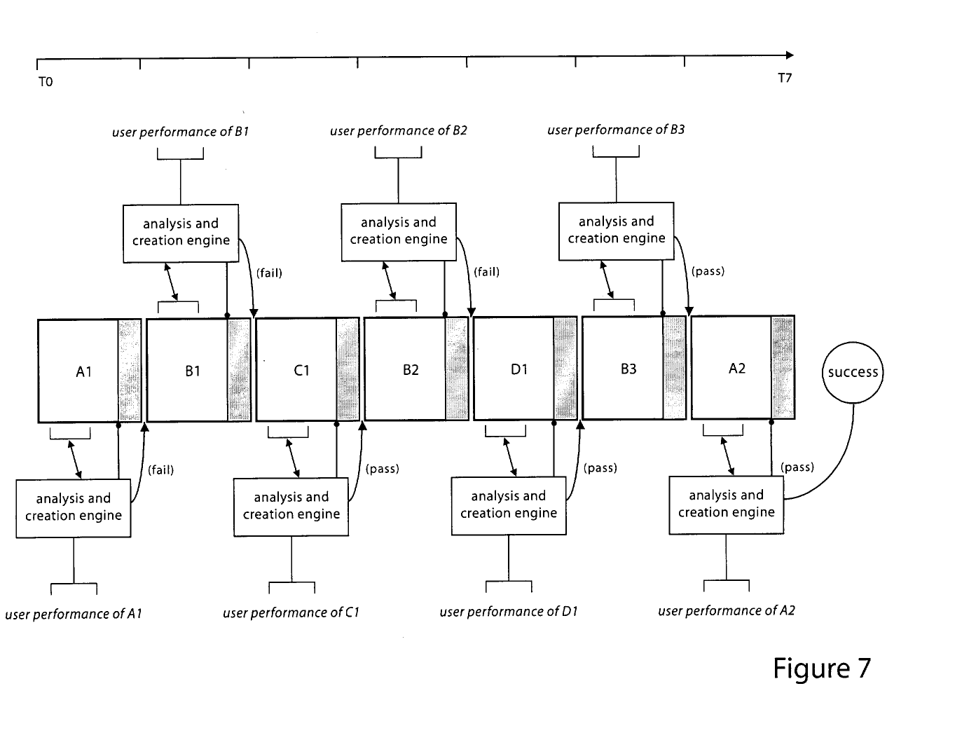

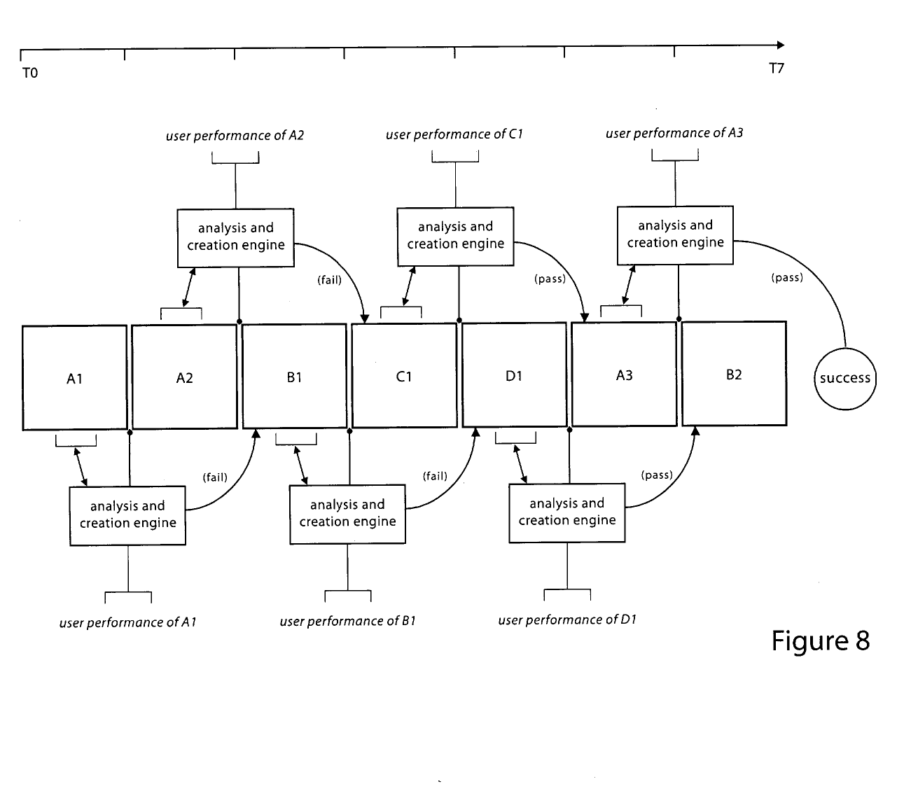

FIGS. 6, 7, and 8 describe an example of each of these methods of the seamless real-time process of iterating through a series of customized lessons built via the identification of a set of weakest MOs.

Additionally, this invention contains methods for the representation of music which facilitates all of the above methods. Visualizations of music in computer-aided education software generally mimic traditional notation in representing musical notes. Any music notation must represent for each note the following attributes: instrument/key information, volume information, timing information. Additionally, music notation may represent conceptual information via a time signature and/or bar lines to represent the underlying pulse structure, as well as optional information regarding the sticking/fingering of particular notes (usually to indicate an unusual pattern which may make a performance easier to execute). A common method utilized in computer-aided education software is to have the entire musical staff scroll “player piano” style, from right to left, defining a particular striking point which indicates when notes are to be played. The current invention extends this general system in the following ways:

F) Methods for the Visualization of Music.

1. The entire staff line is mapped to a three-dimensional topology approximating the layout of the musical instrument. For instance, a drumset is positioned roughly in the shape of a circle, where instruments played primarily by a particular limb are positioned within the appropriate quadrant of the circle, i.e. a ride cymbal channel that is usually played with the right hand would appear in the upper right quadrant. Notes appear in the center of the “tunnel” and move along the appropriate channel until they hit the outer ring in the relative position of the instrument, which indicates that it is time to play that note. Similarly, a piano, which is laid out linearly, can be thought of as a plane with 88 channels, where each note appears from the distance, getting larger as it moves along the appropriate channel for the key, until it hits the outer edge of the plane, which again indicates that it is time to play that note. Stringed instruments, which have a more complex layout, are nonetheless similarly topologically transformed.

2. Utilizing the definition of music as a set of recursively defined Music Objects (described in method set A), the invention describes a method to visually mark notes associated with particular musical concepts with different shapes and or colors.

3. Because this invention has the ability to represent subtleties of performance with regards to timing, the case may arise where a teacher may want to both display the exact performance of a musical piece, as well as the underlying musical structure that the performance is based on. Additionally, complex pieces of music may require more information about the structure of a musical piece than can be described via a time signature. For both these reasons, this invention also describes a method to indicate conceptual markers within the Music Objects that make up a musical piece and display them within the three-dimensional visualization outlined above (F1). These conceptual markers are shown as colored lines and may be positioned at any time and also against one or more channels (denoting different keys/instruments). Additionally, different sets of markers can be differentiated by color and “dottedness”. For example, in a simple piece based around a 4 against 3 polyrhythm, where the notes based on the 4 are played with the right hand, and the notes based on the 3 with the left, we could define a conceptual marker as a solid green line to overlay each 4 pulse for all notes in all channels to be played with the right hand, and a blue dotted-line to overlay each 3 pulse to be played with the left hand.

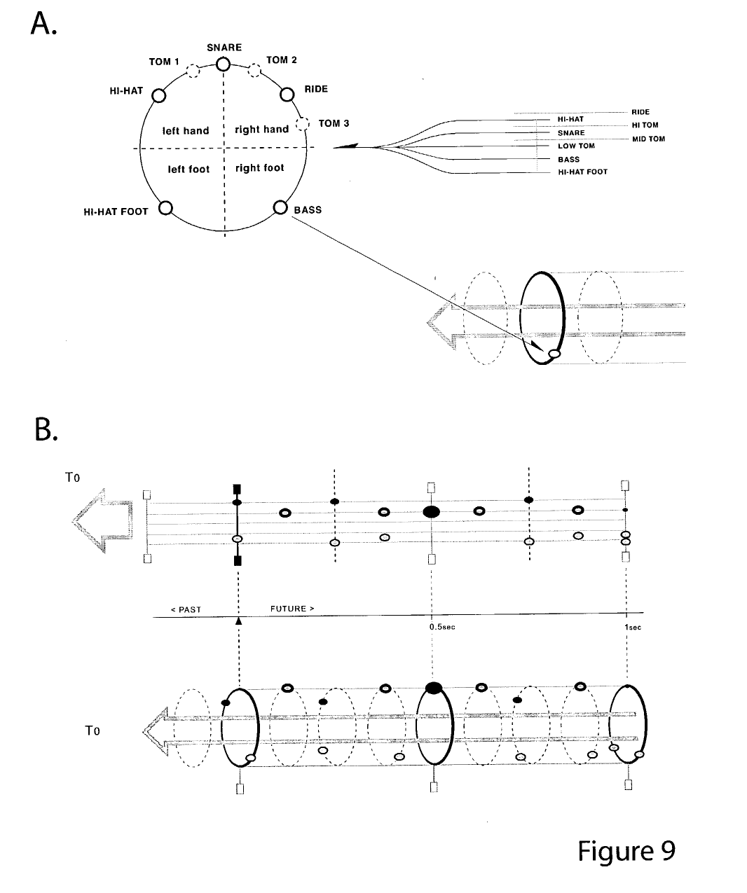

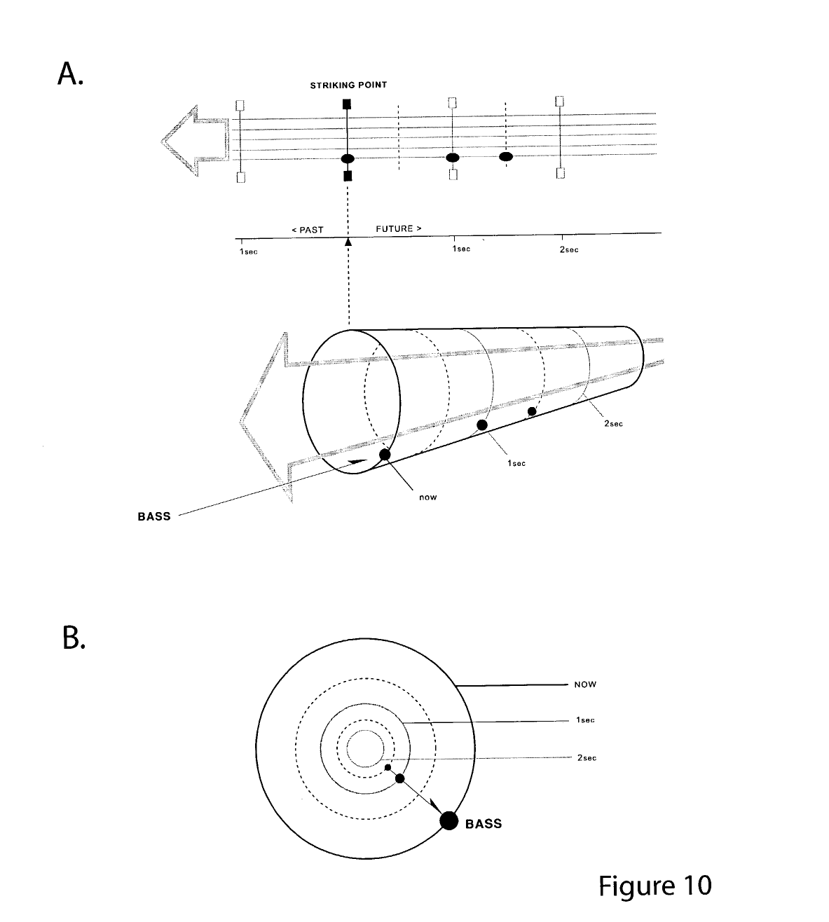

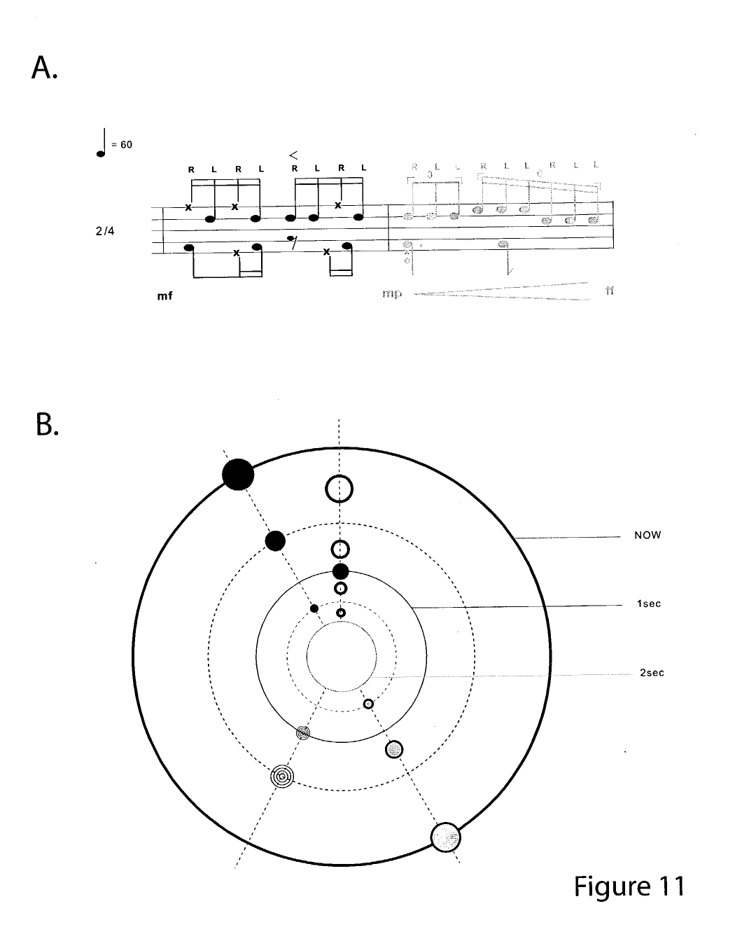

FIGS. 9 through 11 describe the transformation of a musical staff to an appropriate topological representation of an instrument. FIG. 9A illustrates the mapping of the traditional music notation key to different positions on a circle. FIG. 9B further demonstrates the mapping of a set of notes on a staff to a three-dimensional representation of the staff. FIG. 10A demonstrates the transformation of some notes onto a three-dimensional visualization. FIG. 10B illustrates how the user would see the notes looking into the three-dimensional representation of the notes. Finally, FIG. 11B illustrates how the user would see a full bar of a musical phrase looking into the three-dimensional representation. FIG. 11A illustrates the same musical phrase in traditional music notation.

The above methods help to define an intuitive visualization of potentially complex music which will allow a student to understand the conceptual structure(s) of a musical piece as well as to display subtleties of performance, such as timing and touch. This visualization,

1. What I claim as my invention is a computer-aided music education system that assists in the rapid apprehension of technical and conceptual aspects of musical performance based on modelling musical concepts, defined within as music objects (MOs), and providing feedback to a user regarding his or her performance of those MOs.
a. A method for automatically decomposing a musical piece into various MOs.
b. A method for identifying problem areas in a performance by scoring a musical piece and the set of MOs it contains, which have been defined either through claim 1a above, or through an automatic pattern recognition system, or having been demarcated by a human.
c. A method for creating customized lessons based upon the analysis of the set of problem areas identified in claim 1b.
d. A method for the iterative processing of a series of music lessons analyzed and created through the above method (claim 1c).
e. Methods for the real-time presentation of the serial iterative processing defined in the above method (claim 1d).

2. What I claim as my invention is a method to visualize musical information in a precise, intuitive manner so as to facilitate the learning of various musical concepts.
a. A method to transform music notation onto a three-dimensional topological visualization for drums, piano, or any musical instrument.
b. A method to use shapes, colors, sizes, or other visual cues to represent musical concepts, as defined in claim 1, within the visualization described in the above method (claim 2a).
c. A method to present conceptual markers to provide visual contextualizations of a musical performance within the visualization defined in the above method: (claim 2a).
